(19) United States
(12) Patent Application Publication
(10) Pub. No.: US 2026/0169246 A1
(43) Pub. Date: Jun. 18, 2026

(54) CABLE, COMPOSITE CABLE, AND METHOD FOR MANUFACTURING CABLE

(71) Applicant: Proterial, Ltd., Tokyo (JP)

(72) Inventors: Kazuki YAMANE, Tokyo (JP); Nobuki ONO, Tokyo (JP); Takanobu WATANABE, Tokyo (JP)

(21) Appl. No.: 19/371,125

(22) Filed: Oct. 28, 2025

(30) Foreign Application Priority Data
Dec. 12, 2024 (JP) 2024-217156
Sep. 24, 2025 (JP) 2025-158290

(51) Int. Cl. G02B 6/44

(52) U.S. Cl. CPC G02B 6/443; G02B 6/4486

(57) ABSTRACT

A cable includes an assembled core configured by stranding a plurality of cores, and a jacket layer covering around the assembled core collectively, wherein each of the plurality of cores has a coating layer made of thermoplastic resin as an outermost layer, and wherein the assembled core is configured by stranding the plurality of cores around a shrinkage suppressing member which includes a metallic wire and suppresses shrinkage of the coating layer.

### CROSS-REFERENCE TO RELATED APPLICATIONS

The present application is based on Japanese patent application No. 2024-217156 filed on Dec. 12, 2024 and Japanese patent application No. 2025-158290 filed on Sep. 24, 2025, the entire contents of which are incorporated herein by reference.

### TECHNICAL FIELD

The present invention relates to a cable, a composite cable, and a method for manufacturing a cable.

### BACKGROUND ART

Conventionally, thermoplastic resins such as fluororesin, vinyl chloride, and polyethylene have generally been used as coating layers for optical fiber cores and the like. The coating layers made of thermoplastic resins are generally formed by tube extrusion or by extrusion molding at high line speed. However, since the coating layer is formed in a state in which tensile stress is applied, residual stress (strain tending to shrink) remains that attempts to restore the tensile stress. Therefore, for example, if heat is applied to the coating layer when a jacket layer is formed around the core, the coating layer may shrink causing defects such as uneven thickness or cracking.

Conventionally, in order to suppress such defects, the core is introduced into a thermostat chamber or drying room and maintained in a high-temperature environment after extrusion molding of the coating layer, so that the coating layer is preliminarily shrunken.

As prior art documents related to the invention of the present application, there is Patent Literature 1.

### PATENT LITERATURE

Patent Literature 1: JP2008-107519A

### SUMMARY OF THE INVENTION

### Problem to be Solved by the Invention

However, when the core is introduced into a thermostat chamber or drying room as in the conventional manner, manufacturing requires significant time and effort. Accordingly, there is a demand for a cable that can be easily manufactured in a short time while suppressing defects such as uneven thickness caused by shrinkage of the coating layer.

Therefore, it is an object of the present invention to provide a cable and a composite cable that can be easily manufactured in a short time while suppressing defects caused by shrinkage of the coating layer, and a method for manufacturing the cable.

### Measure to Solve the Problem

In order to solve the above problem, the present invention provides a cable comprising: an assembled core configured by stranding a plurality of cores; and a jacket layer covering around the assembled core collectively,
wherein each of the plurality of cores has a coating layer made of thermoplastic resin as the outermost layer, and
wherein the assembled core is configured by stranding the plurality of cores around a shrinkage suppressing member which includes a metallic wire and suppresses shrinkage of the coating layer.

Also, in order to solve the above problem, the present invention provides a composite cable comprising:
a cable core configured by stranding a plurality of cables; and
a sheath covering the cable core collectively,
wherein the cable core includes the cables.

Furthermore, in order to solve the above problem, the present invention provides a method for manufacturing a cable, comprising:
an assembled core configured by stranding the plurality of cores; and
a jacket layer covering around the assembled core collectively,
wherein a coating layer made of thermoplastic resin is formed as an outermost layer of each of a plurality of cores,
wherein an assembled core is formed by stranding the plurality of cores around a shrinkage suppressing member which includes a metallic wire and suppresses shrinkage of the coating layer, and
wherein a jacket layer is formed around the assembled core by extrusion molding.

### Advantageous Effects of the Invention

According to the present invention, it is possible to provide a cable and a composite cable that can be easily manufactured in a short time while suppressing defects caused by shrinkage of the coating layer, and a method for manufacturing the cable.

### BRIEF DESCRIPTION OF DRAWINGS

FIG. 1 is a cross-sectional view perpendicular to the longitudinal direction of a cable according to an embodiment of the present invention.

FIG. 2 is a cross-sectional view perpendicular to the longitudinal direction of a composite cable according to an embodiment of the present invention.

FIG. 3 is a cross-sectional view perpendicular to the longitudinal direction of a composite cable according to a modified example of the present invention.

### MODE TO CARRY OUT THE INVENTION

### Embodiments

Hereinafter, embodiments of the present invention will be described with reference to the accompanying drawings.

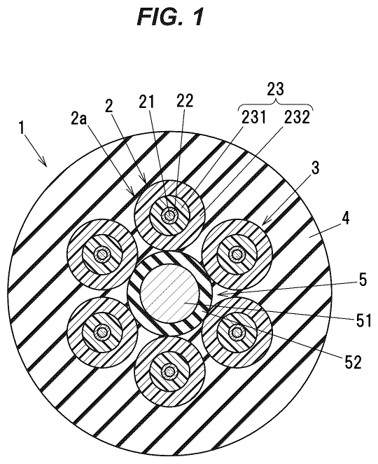

FIG. 1 is a cross-sectional view perpendicular to the longitudinal direction of a cable 1 according to the present embodiment.

As shown in FIG. 1, the cable 1 comprises an assembled core 3 configured by stranding a plurality of cores 2, and a jacket layer 4 covering around the assembled core 3 collectively. Details will be described later, but the cable 1 according to the present embodiment is an optical fiber cable using an optical fiber core 2a as the core 2.

### Assembled Core 3

Each of the plurality of cores 2 included in the assembled core 3 has a coating layer 23 (secondary coating layer 232) made of thermoplastic resin as the outermost layer. In the present embodiment, all of the plurality of cores 2 are optical fiber cores 2a. Here, a case in which the assembled core 3 has six optical fiber cores 2a will be described, but the number of the cores 2 included in the assembled core 3 can be appropriately changed. Furthermore, the cores 2 are not limited to optical fiber cores 2a and may be electric wires such as insulated electric wires or coaxial wires.

The optical fiber core 2a comprises a core 21, a cladding 22 covering the core 21, and a coating layer 23 covering the cladding 22. The coating layer 23 comprises a primary coating layer 231 covering the cladding 22, and a secondary coating layer 232. The thermoplastic resin forming the secondary coating layer 232 as the outermost layer is, for example, fluororesin, vinyl chloride, or polyethylene. Since the optical fiber core 2a has a small diameter, it is desirable to use fluororesin or the like that can be molded thinly as the secondary coating layer 232. Additionally, rubber materials that are difficult to mold thinly are not preferable as the material for the secondary coating layer 232. In order to reduce a diameter of the optical fiber core 2a by thinning the secondary coating layer 232 and to enable stable production at the same time, the thickness of the secondary coating layer 232 is preferably 0.4 mm or more and 0.8 mm or less, and the outer diameter of the optical fiber core 2a is preferably 2.6 mm or more and 3.0 mm or less. The primary coating layer 231 may also be made of a thermoplastic resin, similarly to the secondary coating layer 232. For example, fluororesin, vinyl chloride, polyethylene, or the like can be used. The reason why the coating layer 23 is formed as a two-layer structure consisting of the primary coating layer 231 and the secondary coating layer 232 is that, for example, by placing high-tensile strength fibers (not shown), such as Kevlar (registered trademark), between the primary coating layer 231 and the secondary coating layer 232, it is possible to suppress the application of tensile stress to the optical fiber (the core 21 and the cladding 22).

Thermoplastic resin such as fluororesin used for the secondary coating layer 232 tends to retain residual stress during extrusion molding. Therefore, the secondary coating layer 232 may shrink due to the heat of extrusion molding of the jacket layer 4, and may have uneven thickness or cracking.

More specifically, the coating layer 23 (secondary coating layer 232) has a shrinkage rate of 3% or more and 5% or less when left at 150° C. for one hour. Here, the term “shrinkage rate” refers to an index indicating the degree of shrinkage of the coating layer 23 (secondary coating layer 232) due to temperature changes or stress. It represents the change in length of the coating layer 23 (secondary coating layer 232) before and after a heat treatment (in this case, leaving at 150° C. for one hour). When extrusion strain increases, the molecular structure inside the coating layer 23 (secondary coating layer 232) is more likely to become distorted, and the distortion is released during cooling and solidification, resulting in a higher shrinkage rate. According to the present embodiment, even when the coating layer 23 (secondary coating layer 232) is likely to shrink, it is not necessary to perform a heat treatment process or the like to remove the strain. The shrinkage suppressing member 5 described later can suppress defects caused by the shrinkage of the coating layer 23 (secondary coating layer 232).

To determine the shrinkage rate, a hollow tubular sample of the coating layer 23 (secondary coating layer 232) is prepared. The total length of the sample is set to 150 mm, and a 100 mm gauge mark is placed at the center of the sample. The sample is then subjected to a heat treatment by leaving it in a constant temperature chamber at 150° C. for one hour. After the heat treatment, the sample is cooled, and the distance between the gauge marks on the cooled sample is measured. This measurement is performed three times in total, and the average gauge distance after heat treatment is obtained. Let D1 (100 mm) denote the average gauge distance before heat treatment and D2 (mm) denote the average gauge distance after heat treatment. The shrinkage rate is calculated by the following formula:

$$Shrinkage rate ( \% ) = [ ( D 1 - D 2 ) / D 1 ] \times 100$$

The shrinkage that occurs after extrusion molding is referred to as “shrink-back.” The larger the shrinkage rate, the more likely the shrink-back phenomenon will occur. Shrink-back is a phenomenon in which the residual stress generated during extrusion molding is released by heat cycles such as solar radiation or energization, causing the coating layer 23 to shrink. In general, the line speed and extrusion strain during extrusion molding are closely related to the shear stress (shear rate ×material viscosity). For example, the faster the line speed (i.e., the larger the pay-off tension (tension when sending a line)), the more the material flow inside the extruder changes, and the shear stress increases. As the shear stress increases, extrusion strain increases, and the molecular structure inside the coating layer 23 becomes more susceptible to distortion. As a result, residual stress in the coating layer 23 increases, and the shrinkage rate tends to become larger.

Thus, in the present embodiment, since a material that is relatively prone to shrinkage is used for the coating layer 23 (secondary coating layer 232), it is necessary to suppress the shrinkage of the coating layer 23 (secondary coating layer 232). Accordingly, in the present embodiment, a shrinkage suppressing member 5 including a metallic wire 51, which does not shrink due to the heat of extrusion molding of the jacket layer 4, is provided at the center of the cable, and the cores 2 are stranded around the shrinkage suppressing member 5 so that the metallic wire 51 holds the cores 2 and suppresses shrinkage of the secondary coating layer 232.

In other words, in the present embodiment, the assembled core 3 is configured by stranding a plurality of cores 2 (here, six optical fiber cores 2a) around the shrinkage suppressing member 5 including the metallic wire 51. With this configuration, shrinkage of the coating layer 23 (secondary coating layer 232) in the longitudinal direction of the cable can be suppressed, and uneven thickness or cracking of the coating layer 23 (secondary coating layer 232) can be suppressed.

In the present embodiment, the shrinkage suppressing member 5 has a protective layer 52 made of resin covering the metallic wire 51. With this configuration, compared with a case where the metallic wire 51 alone holds the cores 2, a friction coefficient against the cores 2 can be increased, so that the cores 2 can be held more firmly. As a result, uneven thickness or cracking due to the shrinkage of the coating layer 23 (secondary coating layer 232) can be suppressed more effectively.

As the metallic wire 51, a wire cable configured by stranding steel wires can be used. With this configuration, the cable 1 is more flexible, which facilitates wiring work and the like. In the present embodiment, the shrinkage suppressing member 5 plays a role of suppressing the shrinkage of the coating layer 23 (secondary coating layer 232) of the cores 2, and a role of bearing tension applied to the cable 1. An outer diameter of the metallic wire 51 is 3.2 mm or more and 3.6 mm or less. An outer diameter of the steel wire used for the metallic wire 51 is 2.2 mm or more and 2.6 mm or less.

In the configuration where six cores 2 are stranded around the shrinkage suppressing member 5 as shown in FIG. 1, if a diameter of the shrinkage suppressing member 5 positioned at the center is the same as a diameter of the plurality of optical fiber cores 2a, and if the cross-sectional shape of the shrinkage suppressing member 5 and that of the plurality of optical fiber cores 2a are perfect circles, a diameter of the inscribed circle of the plurality of optical fiber cores 2a is equal to the diameter of the optical fiber cores 2a and the diameter of the shrinkage suppressing member 5. In the present embodiment, by making the diameter of the shrinkage suppressing member 5 larger than the diameter of the inscribed circle of the plurality of optical fiber cores 2a, in other words, by making the diameter of the shrinkage suppressing member 5 larger than the diameter of the optical fiber core 2a, the optical fiber core 2a can be more closely held in contact with the shrinkage suppressing member 5. Therefore, it is preferable to determine the outer diameter of the metallic wire 51 so that the diameter of the shrinkage suppressing member 5 is larger than the diameter of the optical fiber core 2a.

The protective layer 52 is preferably made of a resin composition which mainly comprises a rubber material. With this configuration, since the rubber material has little shrinkage due to heat, shrinkage of the protective layer 52 due to heat during extrusion molding of the jacket layer 4 can be suppressed, and the cores 2 can be more firmly held. As a result, uneven thickness or cracking due to the shrinkage of the coating layer 23 (secondary coating layer 232) can be suppressed more effectively. Furthermore, by forming the protective layer 52 with the rubber material, the friction coefficient of the cores 2 against the protective layer 52 can be increased, and the cores 2 can be more firmly held. As the rubber material used for the protective layer 52, ethylene-propylene rubber or chloroprene rubber can be suitably used.

The material of the protective layer 52 is not limited to a resin composition which mainly comprises a rubber material. For example, the protective layer 52 may be made of the same resin material as the secondary coating layer 232 so that the secondary coating layer 232 does not easily slip on the protective layer 52. Alternatively, the protective layer 52 or the secondary coating layer 232 may be subjected to surface roughening (or processing to form irregularities on the outer surface) so that the secondary coating layer 232 does not easily slip on the protective layer 52.

It is preferable that the protective layer 52 be formed by solid extrusion molding. With this configuration, the resin forming the protective layer 52 enters between the steel wires forming the metallic wire 51, so that the protective layer 52 can be provided in close contact with the metallic wire 51. As a result, displacement of the protective layer 52 in the longitudinal direction relative to the metallic wire 51 can be suppressed, and the cores 2 can be held more firmly. All of the cores 2 forming the assembled core 3 are in direct contact with an outer circumferential surface of the protective layer 52.

Thickness of the protective layer 52 is preferably 0.4 mm or more. By making the thickness of the protective layer 52 0.4 mm or more, the diameter of the shrinkage suppressing member 5 becomes larger than the diameter of the inscribed circle of the plurality of optical fiber cores 2a. Thus, the optical fiber cores 2a can be more closely held in contact with the shrinkage suppressing member 5. In the present embodiment, the thickness of the protective layer 52 is 0.5 mm, and the overall outer diameter of the shrinkage suppressing member 5 is 3.4 mm.

The protective layer 52 is not essential and may be omitted. However, in order to hold the cores 2 more firmly, it is more preferable to provide the protective layer 52. In addition, by providing the protective layer 52, the protective layer 52 also serves as a buffer layer interposed between the metallic wire 51 and the cores 2. As a result, for example, the protective layer 52 can suppress troubles such as disconnection of the cores 2 due to interference of the metallic wire 51 with the cores 2, which may happen when the cable 1 is bent.

If the stranding pitch of the cores 2 stranded around the shrinkage suppressing member 5 is too large, the cores 2 will be in a state close to a straight line, and the effect of suppressing the shrinkage of the coating layer 23 (secondary coating layer 232) may not be sufficiently obtained. Therefore, it is preferable that the stranding pitch of the cores 2 be 250 mm or less. On the other hand, if the stranding pitch of the cores 2 is too small, the required length of the cores 2 becomes longer, which may increase costs. Accordingly, it is more preferable that the stranding pitch of the cores 2 be 60 mm or more and 250 mm or less. Here, the term “stranding pitch” of the cores 2 refers to the distance along the longitudinal direction of the cable between two positions where the location of an arbitrary core 2 in the circumferential direction of the cable coincides.

### Jacket Layer 4

The jacket layer 4 plays a role to protect the assembled core 3, a role to press the cores 2 against the shrinkage suppressing member 5, and a role to suppress the shrinkage of the coating layer 23 (secondary coating layer 232) by holding the cores 2 together with the shrinkage suppressing member 5.

The jacket layer 4 is preferably made of a resin composition which mainly comprises a rubber material. With this configuration, it is possible to suppress shrinkage of the jacket layer 4 when heat is applied to the cable 1, since rubber material has little shrinkage due to heat, and thus, the cores 2 can be firmly held. As a result, uneven thickness or cracking due to the shrinkage of the coating layer 23 (secondary coating layer 232) can be suppressed more effectively.

It is preferable that the jacket layer 4 be formed by solid extrusion molding. With this configuration, the resin forming the jacket layer 4 enters between the cores 2, so that the cores 2 can be held more firmly. In order to make the cable 1 as thin as possible and enable stable production, an outer diameter of the jacket layer 4, that is, an outer diameter of the cable 1, is preferably from 11 mm to 13 mm (11 mm or more and 13 mm or less).

### Method for Manufacturing the Cable 1

When manufacturing the cable 1, first, the coating layer 23 made of thermoplastic resin is formed as the outermost layer of six cores 2 each. Then, the six cores 2 are stranded around the shrinkage suppressing member 5 to form the assembled core 3. Thereafter, the jacket layer 4 is formed around the assembled core 3 by solid extrusion molding. In the present embodiment, the line speed in extrusion molding of the jacket layer 4 is slow, since the jacket layer 4 is made of a resin composition which mainly comprises a rubber material. More specifically, the line speed in extrusion molding of the jacket layer 4 is 3 m/min (at least 5 m/min or less). Therefore, the heat at the time of extrusion molding of the jacket layer 4 tends to adversely affects the cores 2. According to the present embodiment, since the cores 2 are held by the shrinkage suppressing member 5 including the metallic wire 51 that does not shrink due to the heat of extrusion molding of the jacket layer 4, the shrinkage of the coating layer 23 (secondary coating layer 232) can be suppressed even when a resin composition which mainly comprises a rubber material is used as the jacket layer 4. It should be noted that a step of forming the assembled core 3 and a step of forming the jacket layer 4 may be performed collectively in a single production line.

Furthermore, in the present embodiment, relatively inexpensive cores 2 with the coating layer 23 (secondary coating layer 232) formed by tube extrusion molding or extrusion molding at high line speed can be used as the cores 2 (optical fiber cores 2a) for the assembled core 3, since the shrinkage of the coating layer 23 (secondary coating layer 232) can be suppressed. In other words, according to the present embodiment, the cores 2 can be used without pretreatment, even when residual stress remains in their coating layers 23 (secondary coating layer 232). The line speed in extrusion molding of the secondary coating layer 232 is, for example, 10 m/min (at least larger than the line speed in extrusion molding of the jacket layer 4, and more preferably, 8 m/min or more). The coating layer 23 (secondary coating layer 232) has larger residual stress (or residual strain) compared with the jacket layer 4.

### Composite Cable 10

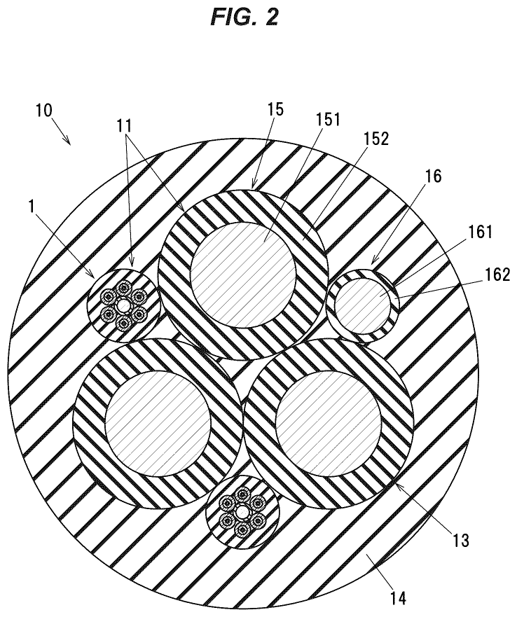

FIG. 2 is a cross-sectional view perpendicular to the longitudinal direction of a composite cable 10 according to the present embodiment. The composite cable 10 is an optical composite cable including the cable 1 (optical fiber cable). Also, the composite cable 10 is a cabtire cable which is used, for example, to supply power to a traveling crane.

The composite cable 10 comprises a cable core 13 configured by stranding a plurality of cables 11, and a sheath 14 covering around the cable core 13 collectively. Here, the cable core 13 is configured by stranding a total of six cables 11, namely three power supply wires 15, one grounding wire 16, and two cables 1 of FIG. 1.

The power supply wire 15 is an insulated wire comprising a conductor 151 formed of stranded wire conductors, and an insulator 152 covering around the conductor 151. The grounding wire 16 is an insulated wire comprising a conductor 161 formed of stranded wire conductors, and an insulator 162 covering around the conductor 161. The insulators 152 and 162 are made of a resin composition which mainly comprises a rubber material. Although not shown in the drawings, the power supply wire 15 may have an outer conductor formed of a braided structure or the like.

The power supply wire 15 has an outer diameter larger than that of the cable 1 and the grounding wire 16. In the cable core 13, the three power supply wires 15 are arranged in a ring shape so as to contact each other (so that the line connecting their centers forms a triangular shape). The two cables 1 and the grounding wire 16 are arranged into three gaps between adjacent power supply wires 15 respectively.

The sheath 14 is formed around the cable core 13 by solid extrusion molding. The sheath 14 is preferably made of a resin composition which mainly comprises a rubber material. In the present embodiment, even when the heat generated at the time of forming the sheath 14 is transmitted to the cores 2 of the cable 1, uneven thickness or cracking is unlikely to occur in the coating layer 23 (secondary coating layer 232) of the cores 2. Thus, the yield is favorable. If a void is present at the center portion of the cable surrounded by the three power supply wires 15, the positions of the power supply wires 15 are likely to shift. Therefore, in the present embodiment, a resin composition mainly comprising the same rubber material as that of the sheath 14 is disposed also at the center portion of the cable.

### Prototype and Evaluation

A prototype of the composite cable 10 shown in FIG. 2 was manufactured, and the presence or absence of shrinkage of the coating layer 23 was evaluated. For the power supply wire 15, a sub-strand was prepared by twisting together thirty-four strands of tin-plated soft copper wires each having an outer diameter of 0.45 mm. Nineteen of these sub-strands were twisted together to form a conductor 151 having a composite stranded structure. The conductor size of the power supply wire 15 was 100 SQ. A semi-conductive butyl tape, obtained by laminating an adhesive layer made of a semi-conductive butyl rubber onto a rayon tape, was helically wound around the conductor 151, and an insulator 152 made of ethylene-propylene rubber with a thickness of 4.5 mm was provided around it. Furthermore, a semi-conductive butyl tape was helically wound around the insulator 152, and an outer conductor made of a braid formed by braiding strands of tin-plated soft copper wires was provided around it. Finally, a rayon tape was wound around the outer conductor to constitute the power supply wire 15.

For the grounding wire 16, a sub-strand was prepared by twisting together thirty-four strands of tin-plated soft copper wires each having an outer diameter of 0.45 mm, and seven of these sub-strands were twisted together to form a conductor 161 having a composite stranded structure. The conductor size of the grounding wire 16 was 38 SQ. A rayon tape was helically wound around the conductor 161, and an insulator 162 made of ethylene-propylene rubber with a thickness of 1.44 mm was provided around it.

For the cable 1, a shrinkage suppressing member 5 was used, which was composed of a metallic wire 51 formed of a wire rope with an outer diameter of 2.4 mm, and a protective layer 52 made of ethylene-propylene rubber provided around the metallic wire 51, resulting in an overall outer diameter of 3.20 mm. As the core 2, an optical fiber core 2a having a core diameter of 50 μm and a cladding diameter of 125 μm was used. Around a cladding 22, a primary coating layer 231 made of fluororesin was provided, high-tensile strength fibers were arranged around it, and a secondary coating layer 232 of fluororesin was formed by tube extrusion molding. The outer diameter of the optical fiber core 2a was 0.58 mm. The pay-off tension during extrusion molding of the secondary coating layer 232 was 1.9 N, and the shrinkage rate of the secondary coating layer 232 after being left at 150° C. for one hour was 3.7%.

Six cores 2 were stranded around the shrinkage suppressing member 5 with a stranding pitch of 112 mm to form an assembled core 3, and a jacket layer 4 made of ethylene-propylene rubber was formed around the assembled core 3 to manufacture the cable 1. The average minimum thickness of the jacket layer 4 was 0.900 mm.

Three power supply wires 15, one grounding wire 16, and two cables 1 were stranded around an unvulcanized chloroprene rubber (rubber material disposed at the cable center) with a stranding pitch of 455 mm to form a cable core 13, and a sheath 14 made of chloroprene rubber was provided around the cable core 13. The average minimum thickness of the sheath 14 was 2.340 mm. The sheathed wire was then covered with lead and vulcanized using a vulcanization tank, and after vulcanization, the lead was stripped off to obtain the composite cable 10.

When the terminal of the obtained composite cable 10 was visually inspected, no shrinkage of the coating layer 23 of the cores 2 contained in the cable 1 was observed.

### Functions and Effects of the Embodiment

As described above, the cable 1 according to the present embodiment comprises the assembled core 3 configured by stranding the plurality of cores 2, and the jacket layer 4 covering around the assembled core 3 collectively,
wherein each of the plurality of cores 2 has the coating layer 23 (secondary coating layer 232) made of thermoplastic resin as the outermost layer, and
wherein the assembled core 3 is configured by stranding the plurality of cores 2 around the shrinkage suppressing member 5 that includes the metallic wire 51 and suppresses the shrinkage of the coating layer 23.

With this configuration, the cores 2 can be held by the metallic wire 51 which does not shrink due to the heat of extrusion molding of the jacket layer 4, so that the shrinkage of the coating layer 23 (secondary coating layer 232) of the cores 2 can be suppressed even when heat is applied to the cores 2 by the extrusion molding of the jacket layer 4, or the like. As a result, uneven thickness or cracking of the coating layer 23 (secondary coating layer 232) can be suppressed. The cable 1 according to the present embodiment does not require a step of introducing the cores 2 into a thermostat chamber or a drying room as in the conventional art, and therefore can be easily manufactured in a short time. In other words, according to the present embodiment, it is possible to realize the cable 1 which can be easily manufactured in a short time, while suppressing defects caused by the shrinkage of the coating layer 23 (secondary coating layer 232).

### Modified Example

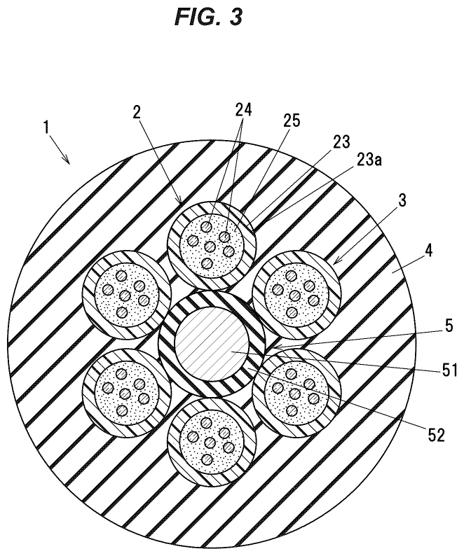

In the above embodiment, a case in which the core 2 includes one optical fiber has been described. However, the present invention is not limited to this configuration, and the core 2 may include multiple optical fibers. For example, as shown in FIG. 3, the core 2 may be configured by accommodating a plurality of optical fibers 24 (six in this example) inside a hollow tubular loose tube 23a that constitutes the coating layer 23. A gel-like filling material 25 is filled in the internal space of the loose tube 23a. The plurality of optical fibers 24 are not stranded, so that unnecessary stress is not applied to the optical fibers 24. The filling material 25 serves to suppress deformation of the loose tube 23a and to prevent abrasion between the optical fibers 24. The loose tube 23a is made of a fluororesin such as ETFE (ethylene-tetrafluoroethylene copolymer). The number of optical fibers 24 included in the core 2 can be changed as appropriate. With this configuration, it is possible to increase the number of optical fibers 24 used while keeping the outer diameter of the cable 1 small.

### Summary of the Embodiments

Next, the technical idea grasped from the above-described embodiment will be described with reference to the reference numerals used in the embodiment. However, the reference numerals in the following description are not limited to the members specifically shown in the embodiment as constituent elements of the claims.

[1] A cable (1) comprising:
an assembled core (3) in which a plurality of cores (2) is stranded together; and
a jacket layer (4) covering around the assembled core (3) collectively,
wherein each of the plurality of cores (2) has a coating layer (23) made of thermoplastic resin as an outermost layer, and
wherein the assembled core (3) is configured by stranding the plurality of cores (2) around a shrinkage suppressing member (5) which includes a metallic wire (51) and suppresses shrinkage of the coating layer (23).

[2] The cable (1) according to [1],
wherein the core (2) is an optical fiber core (2a), and
wherein the metallic wire (51) is formed by stranding steel wires.

[3] The cable (1) according to [1],
wherein the shrinkage suppressing member (5) further comprises a protective layer (52) made of resin provided so as to cover around the metallic wire (51).

[4] The cable (1) according to [3],
wherein the protective layer (52) is made of a resin composition which mainly comprises a rubber material.

[5] The cable (1) according to [3],
wherein the protective layer (52) is formed by solid extrusion molding.

[6] The cable (1) according to [1],
wherein the jacket layer (4) is made of a resin composition which mainly comprises a rubber material.

[7] The cable (1) according to [6],
wherein the jacket layer (4) is formed by solid extrusion molding.

[8] The cable (1) according to [1],
wherein the assembled core (3) is formed by stranding six of the cores (2) around the shrinkage suppressing member (5), and
wherein a diameter of the shrinkage suppressing member (5) is larger than a diameter of the core (2).

[9] The cable (1) according to [1], wherein a stranding pitch of the cores (2) is 250 mm or less.

[10] The cable (1) according to [1], wherein the coating layer (23) has a shrinkage rate of 0.5% or more when left at 150° C. for one hour.

[11] A composite cable (10), comprising:
a cable core (13) configured by stranding a plurality of cables (11); and
a sheath (14) covering around the cable cores (13) collectively,
wherein the cable core (13) includes the cable (1) according to any one of [1] to [10].

[12] A method for manufacturing the cable (1) comprising: the assembled core (3) which is configured by stranding the plurality of cores (2); and the jacket layer (4) that covers around the assembled core (3) collectively,
wherein a coating layer (23) made of thermoplastic resin is formed as an outermost layer of each of the plurality of cores (2),
wherein the assembled core (3) is configured by stranding the plurality of cores (2) around the shrinkage suppressing member (5) which includes a metallic wire (51) and suppresses shrinkage of the coating layer; and
wherein a jacket layer (4) is formed around the assembled core (3) by extrusion molding.

### Note

The above description of the embodiments of the invention does not limit the invention to the scope of the claims. Additionally, it should be noted that not all the combinations of features described in the embodiments are essential to the means for solving the problems of the invention. Furthermore, the invention can be implemented by modifying it as appropriate to the extent that it does not depart from the intent of the invention.

1. A cable, comprising:
an assembled core configured by stranding a plurality of cores; and
a jacket layer covering around the assembled core collectively,
wherein each of the plurality of cores has a coating layer made of thermoplastic resin as an outermost layer, and
wherein the assembled core is configured by stranding the plurality of cores around a shrinkage suppressing member which includes a metallic wire and suppresses shrinkage of the coating layer.

2. The cable according to claim 1,
wherein the core is an optical fiber core, and
wherein the metallic wire is configured by stranding steel wires.

3. The cable according to claim 1,
wherein the shrinkage suppressing member further comprises a protective layer made of resin provided so as to cover around the metallic wire.

4. The cable according to claim 3, wherein the protective layer is made of a resin composition which mainly comprises a rubber material.

5. The cable according to claim 3, wherein the protective layer is formed by solid extrusion molding.

6. The cable according to claim 1, wherein the jacket layer is made of a resin composition which mainly comprises a rubber material.

7. The cable according to claim 6, wherein the jacket layer is formed by solid extrusion molding.

8. The cable according to claim 1,
wherein the assembled core is configured by stranding six of the cores around the shrinkage suppressing member, and
wherein a diameter of the shrinkage suppressing member is larger than a diameter of the core.

9. The cable according to claim 1, wherein a stranding pitch of the cores is 250 mm or less.

10. The cable according to claim 1, wherein the coating layer has a shrinkage rate of 0.5% or more when left at 150° C. for one hour.

11. A composite cable, comprising:
a cable core configured by stranding a plurality of cables; and
a sheath covering around the cable core collectively,
wherein the cable core includes the cable according to claim 1.

12. A method for manufacturing a cable,
which is for manufacturing the cable comprising an assembled core configured by stranding the plurality of cores and a jacket layer covering around the assembled core collectively,
wherein a coating layer made of thermoplastic resin is formed as an outermost layer of each of the plurality of cores;
wherein the assembled core is configured by stranding the plurality of cores around a shrinkage suppressing member which includes a metallic wire and suppresses shrinkage of the coating layer; and
wherein the jacket layer is formed around the assembled core by extrusion molding.
